(19) United States
(12) Patent Application Publication
(10) Pub. No.: US 2012/0274248 A1
(43) Pub. Date: Nov. 1, 2012

(54) ELECTRONICALLY COMMUTATED ELECTRICAL MOTOR HAVING A CALIBRATED MOTOR TORQUE CONSTANT

(75) Inventor: David Fricker, Oberhoffen Sur Moder (FR)

(73) Assignee: ROBERT BOSCH GMBH, Stuttgart (DE)

(21) Appl. No.: 13/502,669

(22) PCT Filed: Oct. 8, 2010
(86) PCT No.: PCT/EP2010/065053

§ 371 Date: Apr. 18, 2012

(30) Foreign Application Priority Data
Oct. 20, 2009 (DE) 102009045822.0

(51) Int. Cl. H02P 6/18

(52) U.S. Cl. 318/400.04

(57) ABSTRACT

The invention relates to an electrically commutated electrical motor having a stator and having an in particular permanent-magnetically designed rotor. The electronically commutated electrical motor also has a control unit which is connected to the stator and designed to actuate the stator for generating a magnetic rotary field. The control unit is designed to detect a voltage induced in at least one stator coil of the stator and to determine a motor torque constant representing an achievable torque in dependence on a rotational speed signal representing a rotor circumferential frequency of the rotor. According to the invention, the control unit in the electronically commutated electrical motor of the aforementioned type is designed to detect a frequency content of the motor torque constant and to actuate the stator for generating a torque in dependence of the frequency content, in particular a frequency amplitude of the motor torque constant.

### BACKGROUND OF THE INVENTION

The invention relates to an electronically commutated electrical motor having a stator and having a rotor which is, in particular, formed using permanent magnets. The electronically commutated electrical motor also has a control unit which is connected to the stator and is designed to drive the stator, in particular stator coils of the stator, to generate a rotary magnetic field. The control unit is designed to detect a voltage induced in at least one stator coil of the stator or to determine the induced voltage as a function of a stator coil current flowing through a stator coil and to determine a motor torque constant representing a torque which can be achieved as a function of a rotor position signal representing a rotor position of the rotor and/or a rotational speed signal representing a rotor revolution frequency of the rotor. The control unit is preferably designed to drive the stator as a function of the motor torque constant.

DE 10 2007 020 068 A1 discloses a method and an apparatus for determining a motor torque constant of an electrical motor, in which the motor torque constant of the electrical motor is determined during operation of the motor as a function of an induced voltage produced by the electrical motor.

### SUMMARY OF THE INVENTION

According to the invention, the control unit in the electronically commutated electrical motor of the type mentioned at the outset is designed—preferably during operation of the electrical motor—to detect a frequency content of the motor torque constant and to drive the stator to produce a torque as a function of the frequency content, in particular a frequency amplitude of the motor torque constant.

The electrical motor preferably has a rotor position sensor and/or a rotational speed sensor, the rotor position sensor being designed to detect a rotor position of the rotor and to generate the rotor position signal representing the rotor position. The rotational speed sensor is preferably designed to detect the rotor revolution frequency of the rotor and to generate the rotational speed signal representing the rotor revolution frequency.

Detecting the frequency content of the motor torque constant advantageously makes it possible to accurately detect a rotor magnetic field strength and thus also factors influencing the motor torque constant. Furthermore advantageously, the electronically commutated electrical motor designed in this manner can advantageously detect manufacturing tolerances, for example eccentricity of the stator coils, locally shifted permanent magnets, electrical tolerances of components, in particular of the stator coils, different magnetization of the permanent magnets with respect to one another, different magnetic field profiles of the stator coils with respect to one another and a temperature-dependent magnetic field strength of magnetic components, for example the rotor formed using permanent magnets. For example, the material ferrite has a lower magnetic field strength at low temperatures in the region of −40 degrees Celsius than at 20 degrees Celsius. The material neodymium has a lower magnetic field strength at high temperatures, for example at 120 degrees Celsius, than at 20 degrees Celsius. The electrical motor may thus be easily calibrated during operation, for example, with the result that a torque which can be achieved can be detected over one rotor revolution—for example in one-degree steps—and the motor torque constant determined in this respect can be used to drive the stator further or can be stored.

The electronically commutated electrical motor designed in this manner can advantageously detect the motor torque constant over one rotor revolution, more preferably over at least part of a rotor revolution, in particular 120 degrees electrical for one stator coil, or more preferably only 90 degrees, or 60 degrees electrical for three stator coils, and thus can detect the mechanical and/or electrical efficiency of the electrical motor during motor operation by determining the motor torque constant.

In this case, the motor torque constant is related to the torque of the electrical motor which is to be achieved as follows:

P_{electrical}=U_{ind}·Iₚₕₐₛₑ (1)

P_{mechanical}=M·ω (2)

M=Iₚₕₐₛₑ·B·l·r (4)

where:

U_{ind}=induced voltage

P=power

M=torque

ω=angular frequency

B=magnetic flux density

l=length of a conductor of the stator coil through which current flows

r=distance between the conductor and a rotor longitudinal axis of the rotor.

When the electrical and mechanical powers are equivalent, the following results for the induced voltage U_{ind}

$${U}_{ind} = \frac{M \cdot ω}{{L}_{phase}} = ω \cdot B \cdot l \cdot r \qquad ( 5 )$$

The common factor in (5) and (4)

k=B·l·r (6)

is referred to as the motor torque constant.

In one preferred embodiment of the electrical motor, the control unit is designed to generate a Fourier transform of the motor torque constant, in particular using fast Fourier transformation, and to drive the stator as a function of the Fourier-transformed motor torque constant. As a result, at least one frequency component or a plurality of frequency components, preferably orders from a frequency spectrum of the motor torque constant, can advantageously be determined and the stator can be driven as a function of the at least one frequency component, in particular an amplitude or a spectral power density of the frequency component.

In one preferred embodiment of the electrical motor, the control unit is designed to carry out an order analysis of the Fourier-transformed motor torque constant, preferably by means of an order filter, as a function of the rotational speed signal representing the rotor revolution frequency, and to drive the stator as a function of a signal parameter, in particular a signal amplitude, of at least one order of the frequency content of the motor torque constant. As a result, a temperature-dependent torque loss, for example, can be advantageously detected by means of frequency analysis, in particular Fourier frequency analysis, preferably FFT analysis (FFT=Fast Fourier Transformation).

In one advantageous embodiment variant of the electrical motor, the control unit is designed to drive the stator as a function of odd harmonics of the motor torque constant, preferably only as a function of odd harmonics of the motor torque constant. This advantageously saves computation time for determining the effective motor torque constant.

In one advantageous embodiment of the electrical motor, the control unit is designed to generate a time-dependent and/or rotor-position-dependent profile of the motor torque constant by means of inverse Fourier transformation of the Fourier-transformed motor torque constant and to drive the stator as a function of the rotor-position-dependent profile. As a result, at least one matrix operation, preferably a multiplicity of matrix operations, can be advantageously carried out by the control unit in order to generate a time-dependent and location-dependent (with reference to one rotor revolution) profile of the motor torque constant during operation of the motor.

For example, the control unit is designed to generate a time-dependent and/or rotor-position-dependent profile of the motor torque constant by means of selective order filtering of inverse Fourier transformation of the Fourier-transformed motor torque constant and to drive the stator as a function of the time-dependent and/or rotor-position-dependent profile.

In one advantageous embodiment of the electrical motor, the control unit is designed to drive the stator as a function of a predetermined rotor angle range, preferably 120 degrees electrical, more preferably 90 degrees electrical, particularly preferably 60 degrees electrical, of the motor torque constant. With a rotor angle range of 60 degrees, a period of an induced voltage for a stator coil may advantageously be composed of the signal profiles of the induced voltages of three stator coils. Only the induced voltages of three stator coils thus need to be detected over a rotor angle range of 60 degrees in order to compose the induced voltage for an average stator coil property by adding the signal profiles of the three stator coils.

Computation time and/or measuring time can thus be advantageously saved and mirror symmetry of a signal of the induced motor voltage and thus of the motor torque constant can be advantageously used.

The control unit is formed, for example, by a microprocessor, a microcontroller or an FPGA (FPGA=Field Programmable Gate Array).

In another embodiment of the electrical motor—independently of or in addition to the above-described variant with a Fourier transformer—the control unit can determine the motor constant—in particular without a phase shift—by means of a low-pass filter. For this purpose, the control unit may apply, for example, the same filter or an identical filter twice in temporal succession to the time signal of the motor torque constant or to the induced voltage, preferably first in the forward direction and then in the reverse direction. As a result, the amplitudes of the frequency components are advantageously adapted only in the frequency spectrum. The low-pass filter is an FIR filter (FIR=Finite Impulse Response), for example.

The invention also relates to a method for driving an electronically commutated electrical motor having a stator and a rotor which is, in particular, formed using permanent magnets, in particular the electrical motor described above. In the method, a motor torque constant representing a torque of the electrical motor which can be produced is detected, preferably during operation of the electrical motor, in particular as a function of an induced voltage during rotation of the rotor, a frequency content of the motor torque constant being detected, and the stator being driven to produce a torque as a function of the frequency content, in particular a frequency amplitude, of the motor torque constant.

In the method, a Fourier transform of the motor torque constant is preferably generated, in particular by means of FFT analysis, and the stator is driven as a function of the Fourier-transformed motor torque constant.

In the method, an order analysis of the Fourier-transformed motor torque constant is also preferably carried out, in particular using an order filter, and the stator is driven as a function of a signal parameter, in particular a signal amplitude, of at least one order of the motor torque constant. In this case, an order is a higher harmonic frequency of a fundamental frequency.

In one preferred embodiment of the method, the stator is driven as a function of only odd harmonics of the motor torque constant.

In the method, a time-dependent and/or rotor-position-dependent profile of the motor torque constant is preferably generated by means of inverse Fourier transformation of the Fourier-transformed motor torque constant and the stator is driven as a function of the rotor-position-dependent profile.

In one advantageous embodiment variant of the method, a time-dependent and/or rotor-position-dependent profile of the motor torque constant is generated by means of selective order filtering of inverse Fourier transformation of the Fourier-transformed motor torque constant and the stator is driven as a function of the time-dependent and/or rotor-position-dependent profile.

### BRIEF DESCRIPTION OF THE DRAWINGS

FIG. 1 is a diagram of an embodiment of an electrical motor.

FIG. 2 is a graph of an exemplary signal profile representing a location-dependent motor torque constant over a section of a rotor revolution in a region of a stator coil.

FIG. 3 is a graph of frequency components of the motor torque constant illustrated in FIG. 2.

FIG. 4 is a flow chart of an operation of an electronically commutated electrical motor.

### DETAILED DESCRIPTION

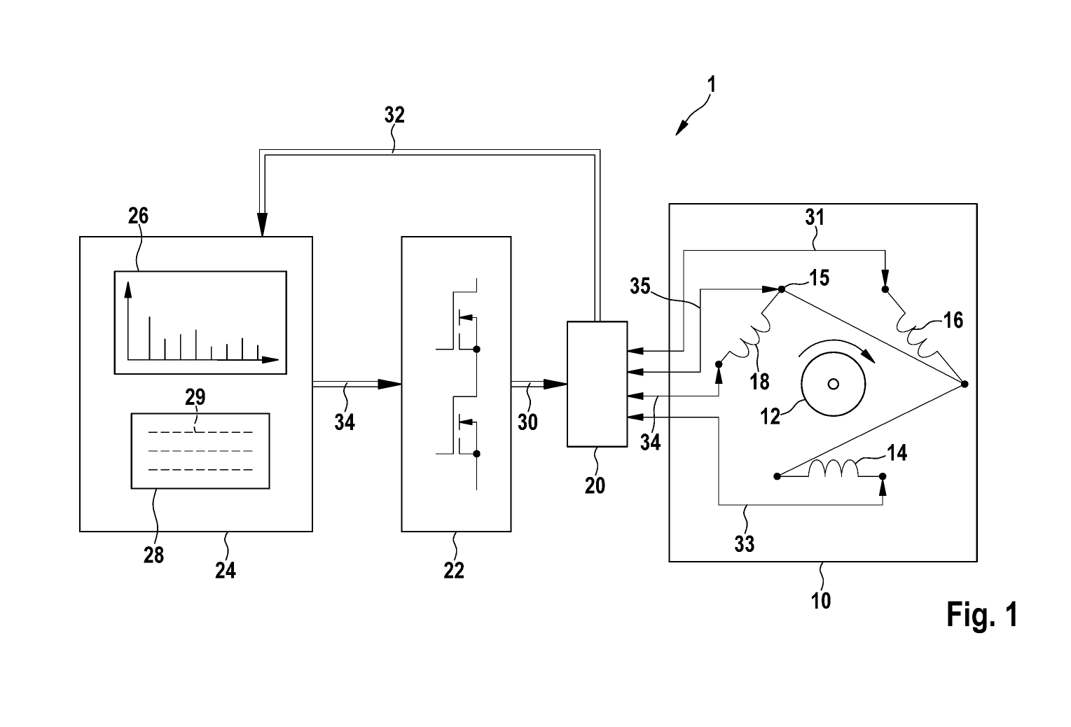

FIG. 1 shows an exemplary embodiment of an electrical motor 1. The electrical motor 1 has a stator 10. The stator 10 has three stator coils, namely a stator coil 14, a stator coil 16 and a stator coil 18, which are arranged together in order to cause a rotor 12 of the electrical motor to rotate by means of a rotary magnetic field. In this exemplary embodiment, the rotor 12 of the electrical motor 1 is formed using permanent magnets. The electrical motor 1 also has a power output stage 22 which is connected, on the output side, to a terminal 20 for the stator 10 via a connection 30. The terminal 20 is connected to a first terminal of the stator coil 14 via a connecting line 33. The terminal 20 is also connected to a first terminal of the stator coil 18 via a connecting line 34 and is connected to a first terminal of the stator coil 16 via a connecting line 31. The second terminals of the stator coils 14, 16 and 18 are each connected to a common star connection 15. The star connection 15 is connected to the terminal 20 via a connecting line 35. The terminal 20 is also connected to a control unit 24 of the electrical motor 1 via a connection 32. The control unit 24 can detect voltages induced in each of the stator coils 14, 16 and 18 via the connection 32, the terminal 20 and the connecting lines 31, 33, 34, and additionally the connecting line 35 for example, of the stator coils 14, 16 and 18. Orders of third degree or of a multiple of third degree, for example a sixth or ninth order, can be detected via the star connection 15, for example. The stator coils 14, 16 and 18 may each be energized by the power output stage 22 via the terminal 20 and the connection 30 in order to generate the rotary magnetic field. The control unit 24 is connected, on the output side, to the power output stage 22 via a connection 34 and is designed to drive the power output stage 22 to energize the stator coils 14, 16 and 18 in such a manner that the rotary magnetic field for rotating the rotor 12 can be generated using the stator coils 14, 16 and 18.

The control unit 24 is designed to detect a respective induced voltage via the connection 32 and the terminal 20 of the stator coils 14, 16 and 18 and to subject said voltage to analog/digital conversion. The control unit 24 is designed to divide each of the induced voltages, which have been previously subjected to analog/digital conversion, by the rotor revolution frequency of the rotor 12 in a further step and thus to determine a motor torque constant for each phase, that is to say for each stator coil of the stator coils 14, 16 and 18. In this case, the motor torque constant can be determined, in particular calculated, as follows:

$$ak = Δ α \cdot {\sum }_{j = 0}^{n - 1} Ku ( j \cdot Δ α ) \cdot cos ( k \cdot j \cdot Δα ) and bk = Δ α \cdot {\sum }_{j = 0}^{n - 1} Ku ( j \cdot Δ α ) \cdot sin ( k \cdot j \cdot Δα ) \qquad ( 7 )$$

where

aₖ, bₖ=Fourier coefficients

Kᵤ=motor torque constant for a stator coil of the phase U

k=wave number,

$$k = \frac{2 Π}{λ} ,$$

where λ=wavelength

n=number of samples over one period.

In vector notation, the frequency vector of the motor constant can be advantageously calculated as a matrix [F]:

$$\begin{matrix}[ F ] = [ \begin{matrix}a 1 \\ ⋮ \\ am \\ b 1 \\ ⋮ \\ bm\end{matrix} ] \\ [ \begin{matrix}Δ α \cdot cos ( 1 \cdot 0 \cdot Δ α ) & … & Δ α \cdot cos ( 1 \cdot ( n - 1 ) \cdot Δ α ) \\ ⋮ & ⋱ & ⋮ \\ Δ α \cdot cos ( m \cdot 0 \cdot Δ α ) & … & Δ α \cdot cos ( m \cdot ( n - 1 ) \cdot Δ α ) \\ Δ α \cdot sin ( 1 \cdot 0 \cdot Δ α ) & … & Δ α \cdot sin ( 1 \cdot ( n - 1 ) \cdot Δ α ) \\ ⋮ & ⋱ & ⋮ \\ Δ α \cdot sin ( m \cdot 0 \cdot Δ α ) & … & Δ α \cdot sin ( m \cdot ( n - 1 ) \cdot Δ α )\end{matrix} ] \cdot \\ [ \begin{matrix}Ku ( 0 \cdot Δ α ) \\ ⋮ \\ Ku ( ( n - 1 ) \cdot Δ α )\end{matrix} ] \\ = [ FFT ] \cdot [ K ]\end{matrix} \qquad ( 8 )$$

where

[K]=motor constant vector

[FFT]=operator of a time-discrete Fourier transformation.

Reducing the sampled rotor angle range to 90 degrees or preferably 60 degrees, for example, makes it possible to use a reduced motor torque constant Kr as a vector as follows:

$$[ Kr ] = [ \begin{matrix}Ku ( 0 \cdot Δ α ) \\ Kv ( 0 \cdot Δ α ) \\ Kw ( 0 \cdot Δ α ) \\ ⋮ \\ Ku ( ( {n}_{2} - 1 ) \cdot Δ α ) \\ Kv ( ( {n}_{2} - 1 ) \cdot Δ α ) \\ Kw ( ( {n}_{2} - 1 ) \cdot Δ α )\end{matrix} ] \qquad ( 9 )$$

where

Kᵤ=motor torque constant in the region of the stator coil of phase U

Kᵥ=motor torque constant in the region of the stator coil of phase V

K_{w}=motor torque constant in the region of the stator coil of phase W

where n₂ is the number of samples of the rotor angle range, for example over 60 degrees or 90 degrees electrical.

The frequency vector [F] can then be replaced by a correspondingly equivalent multiplication [FFTr]·[Kr].

The control unit 24 is designed to subject the motor torque constant to Fourier transformation in a further step and to determine fundamental waves and harmonics for the rotational speed of the rotor 12 using an order filter 26. The determination can preferably be carried out using FFT analysis. The control unit 24 is designed, for example, to reconstruct a temporal or local profile of the motor torque constant in a further step using the previously determined frequency components, in particular at least one order, preferably two orders or more preferably a plurality of orders. The profile 29 of the motor torque constant may be stored in a memory 28, for example. The memory 28 may be part of the control unit 24 or may be connected to the latter.

In order to determine the orders, the control unit 24 may determine a rotational speed of the rotor, that is to say the rotor revolution frequency, as a function of a rotational speed signal generated by a rotational speed sensor (not illustrated in this figure) or may determine the rotor revolution frequency as a function of at least one voltage, preferably two or three of the voltages induced in the stator coils 14, 16 and 18.

In order to determine the motor torque constant (below, the constant Kum for the stator coil U in the space domain, in particular the rotor angle range), the control unit 24 may carry out a matrix calculation, for example. In this case, only the orders to be expected can be selectively transformed back in the time and/or space domain, for example. The matrix calculation may be carried out by the control unit 24 as follows, for example:

$$\begin{matrix}[ Kum ] = [ \begin{matrix}Kum ( 0 \cdot Δ α ) \\ ⋮ \\ Kum ( ( nr - 1 ) \cdot Δ α )\end{matrix} ] ( 10 ) \\ = [ \begin{matrix}cos ( 1 \cdot 0 \cdot Δ α ) & … & cos ( m \cdot 0 \cdot Δ α ) & sin ( 1 \cdot 0 \cdot Δ α ) & … & sin ( m \cdot 0 \cdot Δ α ) \\ ⋮ & ⋱ & ⋮ & ⋮ & ⋱ & ⋮ \\ cos ( 1 \cdot ( nr - 1 ) \cdot Δ α ) & … & cos ( m \cdot ( nr - 1 ) \cdot Δ α ) & sin ( 1 \cdot ( nr - 1 ) \cdot Δ α ) & … & sin ( m \cdot ( nr - 1 ) \cdot Δ α )\end{matrix} ] \cdot \\ [ \begin{matrix}a 1 \\ ⋮ \\ am \\ b 1 \\ ⋮ \\ bm\end{matrix} ] \\ = [ R ] \cdot [ F ]\end{matrix}$$

where
[Kum]=vector of the motor torque constant for the phase U in the space domain, in particular the rotor angle range.

The detection range of the motor torque constant or a range of the motor torque constant to be calculated may be restricted to 60 degrees electrical, for example. The control unit may be advantageously designed in this manner because it can be assumed that a signal profile of a motor torque constant signal, which locally represents the motor torque constant, is formed symmetrically and that a profile of the motor torque constant does not have any even harmonics. This advantageously makes it possible to use a mirror symmetry of a signal, in particular of the previously detected motor torque constant signal. The vector of the motor torque constant can then be formed like the vector (9).

The control unit 24 can reconstruct the motor torque constant in the time domain or in the space domain over one rotor revolution according to formula (10), for example.

The control unit may advantageously carry out the fast Fourier transformation in submatrices. This advantageously makes it possible to load the control unit uniformly.

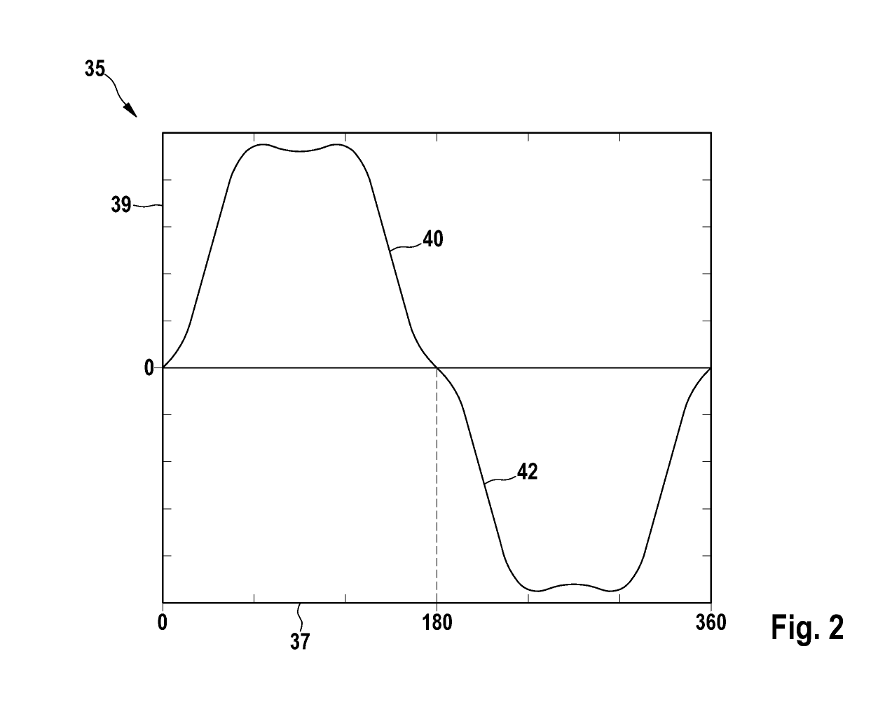

FIG. 2 shows an exemplary embodiment of a signal profile which represents a location-dependent motor torque constant over a section of a rotor revolution in the region of a stator coil. The signal profile was determined by the control unit 24, for example for a stator coil, for example the stator coil 14 in FIG. 1.

In this respect, FIG. 2 shows a graph 35 with an abscissa 37 and an ordinate 39. The abscissa 37 represents a rotor revolution angle of the rotor 12 in FIG. 1 and the ordinate represents an amplitude of the motor torque constant.

The graph 35 also shows a curve with a first partial curve 40 and a second partial curve 42. The partial curve 40 represents a first half-cycle of the signal profile of an induced voltage and the partial curve 42 represents a second half-cycle of the signal profile of the induced voltage, each divided by the rotor revolution frequency of the rotor 12 producing the induced voltage.

It can be seen that the partial curves 40 and 42 each represent a sinusoidal fundamental curve and, in addition thereto, odd harmonics.

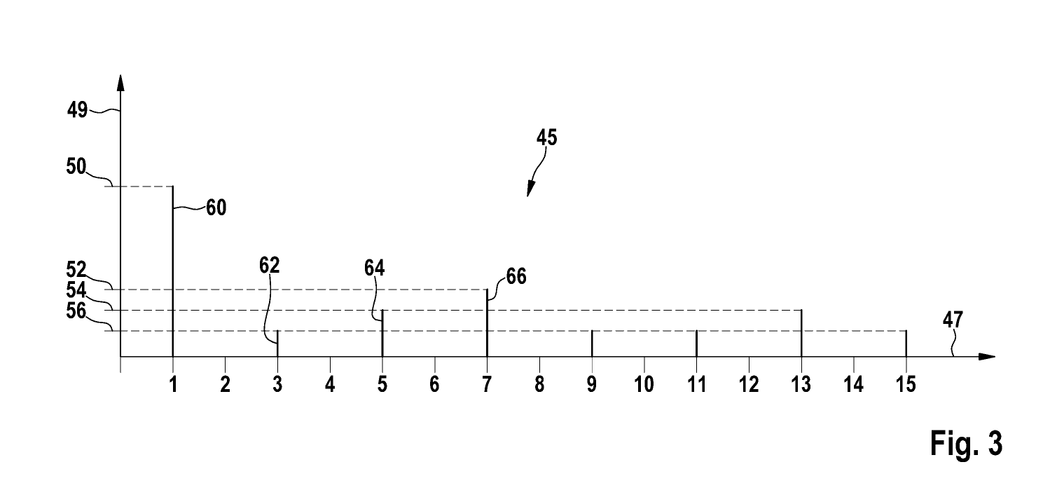

FIG. 3 shows a spectrum 45 having frequency components of the motor torque constant illustrated in FIG. 2. The spectrum 45 is illustrated in a graph having a frequency axis 47 and an amplitude axis 49.

Orders, that is to say harmonics of a fundamental frequency of the motor torque constant illustrated in FIG. 2, are plotted on the frequency axis 47. The spectrum 45 shows a first order 60, that is to say the fundamental frequency which corresponds to the rotor revolution frequency with an amplitude 50, a third order 62 with an amplitude 56, a fifth order 64 with an amplitude 54 and a seventh order 66 with an amplitude 52. The amplitude 52 is less than the amplitude 50, the amplitude 54 is less than the amplitude 52 and the amplitude 56 is less than the amplitude 54.

The control unit 24 illustrated in FIG. 1 can detect the amplitudes 50, 52, 54 and 56 of the harmonics of the motor torque constant signal illustrated in FIG. 2, for example, using the order filter 26.

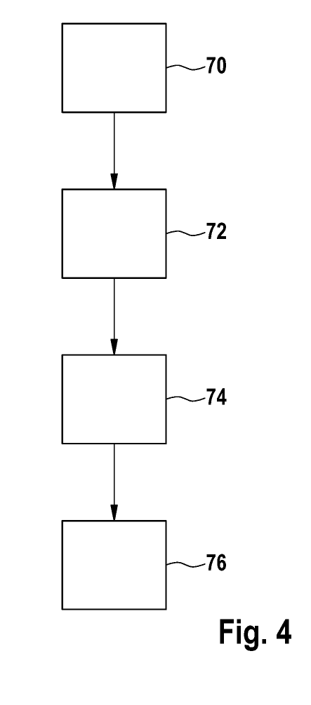

FIG. 4 shows an exemplary embodiment of a method for operating an electronically commutated electrical motor, for example the electrical motor 1 which is illustrated in FIG. 1 and has a rotor 12 formed using permanent magnets.

In the method, a motor torque constant representing a torque of the electrical motor which can be produced is detected in a step 70 during operation of the electrical motor, in particular as a function of an induced voltage during rotation of the rotor.

In a step 72, a Fourier transform of the motor torque constant is generated using FFT analysis and, in a further step 74, an order analysis of the Fourier-transformed motor torque constant is carried out using an order filter, and at least one signal parameter, in particular a signal amplitude, of at least one order of the motor torque constant is determined and stored.

In a step 76, the stator is driven as a function of orders of the motor torque constant, for example only odd orders of the motor torque constant.

1. An electronically commutated electrical motor (1) having a stator (10) and a rotor (12) formed using permanent magnets, and having a control unit (24) which is connected to the stator (10) and is designed to drive the stator (10) to generate a rotary magnetic field, the control unit (24) being designed to detect a voltage induced in at least one stator coil (14, 16, 18) of the stator and to determine a motor torque constant representing a torque which can be achieved as a function of a rotational speed signal representing a rotor revolution frequency of the rotor, characterized in that the control unit (24) is designed to detect a frequency content (45, 60, 62, 64, 66) of the motor torque constant and to drive the stator (10) to produce a torque as a function of the frequency content (45, 60, 62, 64, 66) of the motor torque constant.

2. The electrical motor (1) as claimed in claim 1, characterized in that the control unit is designed to generate a Fourier transform (45) of the motor torque constant, and to drive the stator (10) as a function of the Fourier-transformed motor torque constant.

3. The electrical motor (1) as claimed in claim 2, characterized in that the control unit (24) is designed to carry out an order analysis of the Fourier-transformed motor torque constant and to drive the stator as a function of a signal parameter of at least one order (60, 62, 64, 66) of the frequency content (45) of the motor torque constant.

4. The electrical motor (1) as claimed in claim 2, characterized in that the control unit (24) is designed to drive the stator as a function of only odd orders (60, 62, 64, 66) of the motor torque constant.

5. The electrical motor (1) as claimed in claim 3, characterized in that the control unit (24) is designed to generate a time-dependent and/or rotor-position-dependent profile of the motor torque constant by means of inverse Fourier transformation of the Fourier-transformed motor torque constant and to drive the stator (10) as a function of the time-dependent and/or rotor-position-dependent profile.

6. The electrical motor (1) as claimed in claim 3, characterized in that the control unit (24) is designed to generate a time-dependent and/or rotor-position-dependent profile of the motor torque constant by selective order filtering of inverse Fourier transformation of the Fourier-transformed motor torque constant and to drive the stator (10) as a function of the time-dependent and/or rotor-position-dependent profile.

7. The electrical motor (1) as claimed in claim 1, characterized in that the control unit (24) is designed to drive the stator (10) as a function of a predetermined rotor angle range of the motor torque constant.

8. A method (70, 72, 74, 76) for driving an electronically commutated electrical motor (1) having a stator (10) and a rotor (12) formed using permanent magnets, in which a motor torque constant representing a torque of the electrical motor which can be produced is detected characterized in that a frequency content (45) of the motor torque constant is detected, and the stator (10) is driven to produce a torque as a function of the frequency content of the motor torque constant.

9. The method as claimed in claim 8, characterized in that a Fourier transform (45) of the motor torque constant is generated and the stator is driven as a function of the Fourier-transformed motor torque constant.

10. The method as claimed in claim 8, characterized in that an order analysis of the Fourier-transformed motor torque constant is carried out and the stator is driven as a function of at least one signal parameter of at least one order (60, 62, 64, 66) of the motor torque constant.

11. The method as claimed in claim 8, characterized in that the stator is driven as a function of only odd orders (60, 62, 64, 66) of the motor torque constant.

12. The method as claimed in claim 8, characterized in that a time-dependent and/or rotor-position-dependent profile of the motor torque constant is generated by inverse Fourier transformation of the Fourier-transformed motor torque constant and the stator is driven as a function of the rotor-position-dependent profile.

13. The method as claimed in claim 8, characterized in that a time-dependent and/or rotor-position-dependent profile of the motor torque constant is generated by selective order filtering of inverse Fourier transformation of the Fourier-transformed motor torque constant and the stator is driven as a function of the time-dependent and/or rotor-position-dependent profile.

14. The electric motor (1) as claimed in claim 1, characterized in that the frequency content (45, 60, 62, 64, 66) is a frequency amplitude (60, 62, 64, 66).

15. The electric motor (1) as claimed in claim 2, characterized in that the Fourier transform (45) is a fast Fourier transformation.

16. The electric motor (1) as claimed in claim 3, characterized in that the signal parameter is a signal amplitude.

17. The electric motor (1) as claimed in claim 7 in that the predetermined rotor angle range is one of 90 degrees and 60 degrees.

18. The method (70, 72, 74, 76) as claimed in claim 8, characterized in that the motor torque constant representing a torque of the electrical motor which can be produced is a function of an induced voltage during rotation of the rotor (12) and the frequency content is a frequency amplitude.

19. The method (70, 72, 74, 76) as claimed in claim 9, characterized in that the Fourier transform (45) is a fast Fourier transformation.

20. The method (70, 72, 74, 76) as claimed in claim 10, characterized in that signal parameter is a signal amplitude.
